(19) United States
(12) Patent Application Publication
(10) Pub. No.: US 2013/0083515 A1
(43) Pub. Date: Apr. 4, 2013

(54) LED LAMP

(71) Applicants: SHIH-HSUN WUNG, Tu-Cheng (TW); WEN XU, Shenzhen City (CN)

(72) Inventors: SHIH-HSUN WUNG, Tu-Cheng (TW); WEN XU, Shenzhen City (CN)

(73) Assignees: FOXCONN TECHNOLOGY CO., LTD., Tu-Cheng (TW); FU ZHUN PRECISION INDUSTRY (SHEN ZHEN) CO., LTD., Shenzhen City (CN)

(21) Appl. No.: 13/424,368

(22) Filed: Mar. 19, 2012

(30) Foreign Application Priority Data
Sep. 29, 2011 (CN) 201110292489.0

(51) Int. Cl. F21L 4/02; F21V 29/00; F21L 4/00

(52) U.S. Cl. 362/184; 362/157

(57) ABSTRACT

An LED lamp includes a lamp shell, a lamp holder comprising a power module received in the lamp shell, an LED module received in the lamp shell and electrically connected to the power module, and a heat sink mounted on the LED module. The heat sink includes a fin set having a plurality of fins stacked together. The fin set thermally connects the LED module and the power module. The fin set defines a central chamber to receive the power module therein.

### BACKGROUND

1. Technical Field

The disclosure relates to LED (light emitting diode) lamps, and particularly to an LED lamp with high heat dissipating efficiency.

2. Description of the Related Art

In recent years, LEDs are preferred for use in illuminating devices rather than CCFLs (cold cathode fluorescent lamps) and other traditional lamps due to LEDs' excellent properties, including high brightness, long lifespan, wide color range, and etc.

For an LED, about eighty percents of the power consumed thereby is converted into heat. Generally, an LED lamp includes a plurality of LEDs arranged on a substrate to obtain a desired brightness and illumination area. However, the plurality of LEDs generate a large amount of heat during operation which endangers the normal operation of the LEDs of the LED lamp. A highly efficient heat dissipation device is necessary in order to timely and adequately removes the heat generated by the LED lamp. Otherwise, the brightness, lifespan, and reliability of the LED lamp will be seriously affected.

What is needed, therefore, is an LED lamp which can overcome the limitations described.

### BRIEF DESCRIPTION OF THE DRAWINGS

FIG. 1 is an isometric, assembled view of an LED lamp in accordance with an exemplary embodiment of the disclosure.

FIG. 2 is an exploded view of the LED lamp of FIG. 1.

FIG. 3 is an inverted view of the LED lamp of FIG. 2.

### DETAILED DESCRIPTION

Reference will be made to the drawing figures to describe the present LED lamp in detail.

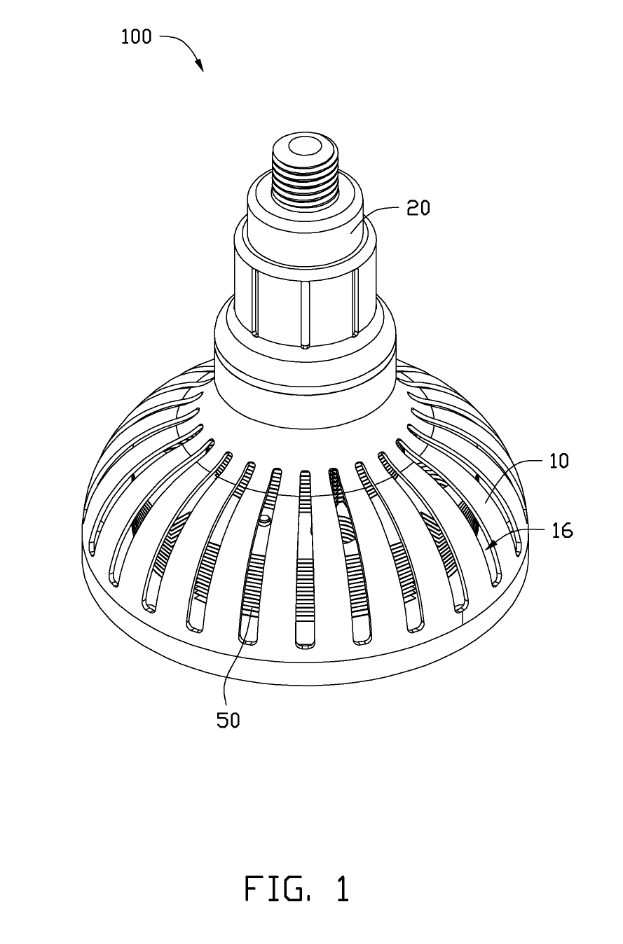

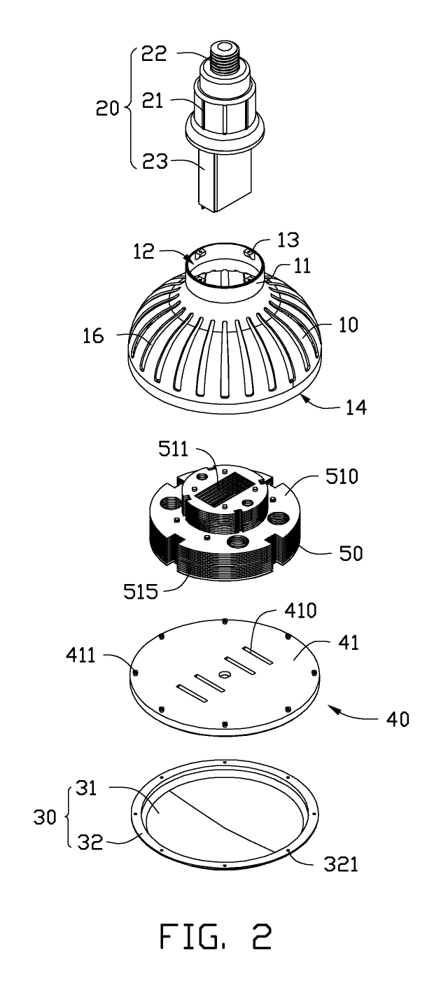

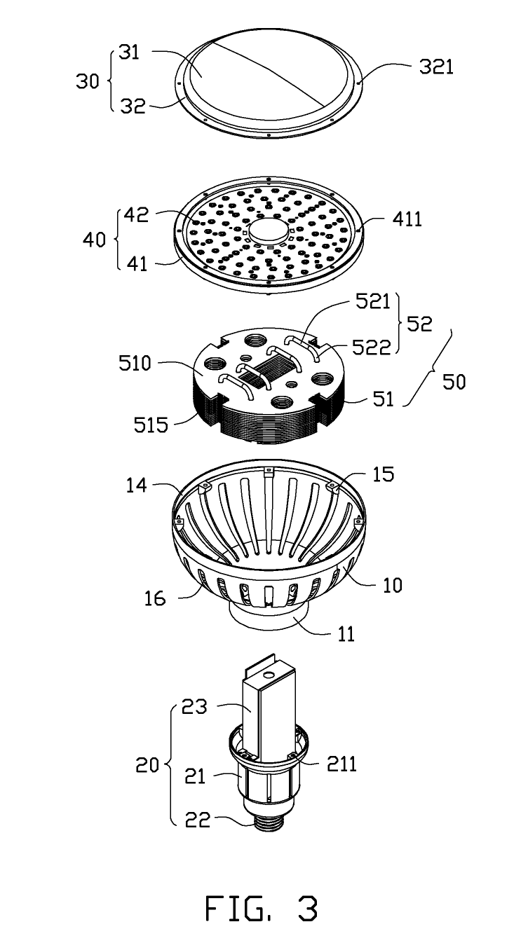

Referring to FIGS. 1-3, an LED lamp in accordance with an exemplary embodiment of the disclosure is illustrated. The LED lamp includes a lamp shell 10, a lamp holder 20, an envelope 30, an LED module 40 and a heat sink 50 received in the lamp shell 10.

The lamp shell 10 has a bowl-shaped configuration. The lamp shell 10 has a collar 11 having an upper opening 12 communicating with an inner of the lamp shell 10. A plurality of first tabs 13 extending inwards from inner surface of the collar 11 at the upper opening 12. The lamp shell 10 defines a bottom opening 14 at a bottom thereof. The lamp shell 10 forms a plurality of second tabs 15 evenly extending from a circular bottom edge thereof. The lamp shell 10 defines a plurality of vertical slits 16 in a body thereof between the collar 11 and the bottom of the lamp shell 10. The vertical slits 16 are evenly defined in the body along a circumferential direction thereof and extend along a top-to-bottom direction of the lamp shell 10.

The lamp holder 20 includes a main body 21, an electrical connector 22 engaged at a top end of the main body 21 and a power module 23 extending downwardly from the main body 21. The power module 23 provides drive power, control circuit and power management for the LED module 40. The power module 23 electrically connects the LED module 40 and the electrical connector 22 by electrical wires (not shown). A plurality of third tabs 211 extends inwards from a bottom of the main body 21 of the lamp holder 20.

The envelope 30 is generally made of plastic, glass, or other suitable material availing to transmit light and prevent foreign articles from entering the LED lamp 100 to contaminate the LED module 40. The envelope 30 is engaged with the bottom of the lamp shell 10 to close the bottom opening 14. The envelope 30 includes a circular base 31 and an annular flange 32 extending from the circular base 31. The annular flange 32 defines a plurality of through holes 321.

The LED module 40 includes a circular substrate 41 and a plurality of LEDs 42 mounted at a bottom surface of the substrate 41. The substrate 41 defines a plurality of straight grooves 410 in an upper surface and a plurality of mounting holes 411 in a peripheral portion of the upper surface of the substrate 41, corresponding to the second tabs 15 of the lamp shell 10 and surrounding the grooves 410.

The heat sink 50 includes a fin set 51 and a plurality of heat pipes 52 extending through the fin set 51 and contacting the substrate 41 of the LED module 40. The fin set 51 includes a plurality of fins 510 stacked to each other. The fins 510 are parallel to the substrate 41. The bottom one of the fins 510 thermally contacts the substrate 41. Each of the heat pipes 52 is U-shaped and has a bottom evaporating portion 521 received in a corresponding straight groove 410 of the substrate 41 and two condensing portions 522 extending upwards from two ends of the evaporating portion 521. The condensing portions 522 extend through the fins 510 to transfer heat from the substrate 41 of the LED module 40 to the fin set 51. The fin set 51 defines a receiving chamber 511 in a central portion thereof. The fins 510 are spaced from each other to define a plurality of horizontal channels 515 therebetween. The channels 515 between the fins 510 communicate with the receiving chamber 511 and the vertical slits 16 of the lamp shell 10. The power module 23 is received in the receiving chamber 511 of the fin set 51. In this embodiment, the fin set 51 includes a bottom part with a first diameter and an upper part with a second diameter smaller than the first diameter of the bottom part to meet the bowl-shaped configuration of the lamp shell 10.

In assembly, the lamp holder 20 is mounted on the lamp shell 10 with screws (not shown) engaging the first tabs 13 of the lamp shell 10 with the third tabs 211 of the lamp holder 20. The LED module 40 and the heat sink 50 are received in the lamp shell 10 and the envelope 30 is engaged in the bottom opening 14 of the lamp shell 10. Fasteners (not shown) extend through the through holes 321 of the annular flange 32 of the envelope 30, the mounting holes 411 of the LED module 40 and are engaged in the second tabs 15 of the lamp shell 10, thereby assembling the envelope 30, the LED module 40 and the lamp shell 10 together.

In use, heat produced by the LEDs 42 can be quickly transferred to the fins 510 via the heat pipes 52 connecting the LED module 40 and the fins 510. The heat produced by the LEDs 210 is then dissipated away to air in the channels 515 defined between the fins 510. The air in the channels 515 flow outwards to ambient environment through the slits 16 of the lamp shell 10, whereby the heat dissipation efficiency of the LED lamp 100 can be improved. Furthermore, heat generated by the power module 23 transfers to the fins 510 and is dissipated to air in the channels 515 between the fins 510. The heat generated by the power module 23 is also timely and adequately removed thereby avoiding a too high temperature of the power module 23.

It is to be further understood that even though numerous characteristics and advantages have been set forth in the foregoing description of the embodiment(s), together with details of the structures and functions of the embodiment(s), the disclosure is illustrative only; and that changes may be made in detail, especially in the matters of shape, size, and arrangement of parts within the principles of the disclosure to the full extent indicated by the broad general meaning of the terms in which the appended claims are expressed.

What is claimed is:

1. An LED lamp, comprising:
a lamp shell;
a lamp holder comprising a power module received in the lamp shell;
an LED module received in the lamp shell and electrically connected to the power module; and
a heat sink mounted on the LED module, the heat sink comprising a fin set having a plurality of fins stacked together, the fin set thermally connecting the LED module and the power module, the fin set defining a central chamber to receive the power module therein.

2. The LED lamp of claim 1, wherein the fin set defines a plurality of channels between the fins, the lamp shell defining a plurality of vertical slits from top to bottom, the channels communicate with the receiving chamber of the fin set and the vertical slits of the lamp shell.

3. The LED lamp of claim 1, wherein the LED module comprises a circular substrate and a plurality of LEDs mounted at a bottom surface of the substrate, the fin set thermally contacting the substrate.

4. The LED lamp of claim 3, wherein the heat sink further comprises a plurality of heat pipes, each of the heat pipes comprising an evaporating portion received in the substrate and two condensing portions extending through the fins.

5. The LED lamp of claim 4, wherein the fins are parallel to the substrate, a bottom one of the fins thermally contacting the substrate.

6. The LED lamp of claim 1, wherein the fin set includes a bottom part with a first diameter and an upper part with a second diameter smaller than the first diameter of the bottom part to meet a bowl-shaped configuration of the lamp shell.

7. The LED lamp of claim 1, wherein the lamp holder further comprises a main body fixed to the lamp shell and an electrical connector engaged at a top end of the main body, the power module extending downwardly from the main body.

8. An LED lamp, comprising:
a lamp shell defining a plurality of slits therein;
a lamp holder comprising a power module received in the lamp shell;
an LED module received in the lamp shell and electrically connected to the power module; and
a heat sink mounted on the LED module, the heat sink comprising a fin set having a plurality of fins stacked together, the fin set thermally connecting the LED module and the power module, the fin set defining a central chamber to receive the power module therein, the fin set defining channels communicating with the receiving chamber of the fin set and the slits of the lamp shell.

9. The LED lamp of claim 8, wherein the channels of the fin set are perpendicular to the slits of the lamp shell.

10. The LED lamp of claim 8, wherein the LED module comprises a circular substrate and a plurality of LEDs mounted at a bottom surface of the substrate, the substrate is mounted at a bottom of the lamp shell and thermally contacting the fin set.

11. The LED lamp of claim 10, wherein the heat sink further comprises a plurality of heat pipes, each of the heat pipes comprising an evaporating portion received in the substrate and two condensing portions extending through the fins.

12. The LED lamp of claim 11, wherein the fins are parallel to the substrate, a bottom one of the fins thermally contacting the substrate.

13. The LED lamp of claim 8, wherein the fin set includes a bottom part with a first diameter and an upper part with a second diameter smaller than the first diameter of the bottom part to meet a bowl-shaped configuration of the lamp shell.

14. The LED lamp of claim 8, wherein the lamp holder further comprises a main body fixed to the lamp shell and an electrical connector engaged at a top end of the main body, the power module extending downwardly from the main body.
